(19) United States
(12) Patent Application Publication
(10) Pub. No.: US 2025/0382004 A1
(43) Pub. Date: Dec. 18, 2025

(54) METHOD TO CONTROL A STEER-BY-WIRE STEERING SYSTEM OF A ROAD VEHICLE AT POWER INTENSIVE MANEUVERS

(71) Applicants: thyssenkrupp Presta AG, Eschen (LI); HONDA MOTOR CO., LTD., Tokyo (JP)

(72) Inventors: Levente PÁSZTOR, Budapest (HU); Munetsugu HANJI, Wako-shi (JP); Yosuke OJIMA, Wako-shi (JP); Yoshinobu WATANABE, Wako-shi (JP); Takaya YAMAGUCHI, Wako-shi (JP)

(21) Appl. No.: 19/315,965

(22) Filed: Sep. 2, 2025

Related U.S. Application Data
(63) Continuation of application No. PCT/EP2023/055350, filed on Mar. 2, 2023.

(51) Int. Cl. B62D 5/04; B62D 5/00

(52) U.S. Cl. CPC B62D 5/046; B62D 5/001; B62D 5/0421; B62D 5/0442; B62D 5/0481

(57) ABSTRACT

A method to control a steer-by-wire steering system for a road vehicle, the steer-by-wire steering system including a steering, a road wheel actuator to actuate road wheels via a rack, and a controller configured or programmed to include a position controller configured or programmed to calculate, based on an actual rack position and a rack position request, a target rack position for the road wheel actuator, the method including, in response to a requested rack speed being above a predefined maximum value, limiting the requested rack speed to a maximum rack speed value used by the position controller to calculate the target rack position for the road wheel actuator.

### BACKGROUND OF THE INVENTION

### 1. Field of the Invention

The present invention relates to methods to control steer-by-wire steering systems of road vehicles and to steer-by-wire steering systems for road vehicles.

### 2. Description of the Related Art

In steer-by-wire steering systems, there is no mechanical connection between the steering wheel and the steering rack and the steerable wheels and steering movement is achieved by a position-controlled road wheel actuator, whose reference position is based on the steering wheel angle.

The position controller always acts with motor torque in a way such that the reference position signal is followed by the road wheel actuator. Due to physical limitations of the road wheel actuator motor (such as maximum available motor torque at a certain motor speed), and limitations of the position controller (bandwidth), the reference road wheel angle shows a transient response.

In extreme cases, for instance, when the road wheel actuator is in a degraded state, the duration of the controller settling time can be even longer, which has a negative effect on the maneuverability of the vehicle.

If the road wheel actuator does not have the mechanical power required for satisfactory settling behavior, a so-called post-steering-effect occurs. If, for example, a very fast step steer maneuver is performed on the steering wheel, the road wheels continue to turn during the transient response, even if the maneuver on the steering wheel side has already ended. This can be felt and heard by the driver, and is very disturbing. In extreme cases (e.g., when changing lanes quickly), the rack and the steering wheel can briefly move in opposite directions, which can lead to an undesired situation.

### SUMMARY OF THE INVENTION

Example embodiments of the present invention provide methods to control steer-by-wire steering systems of road vehicles and steer-by-wire steering systems, each of which do not have the disadvantages mentioned above.

A method to control a steer-by-wire steering system for a road vehicle is provided. The steer-by-wire steering system includes a steering, a road wheel actuator to actuate road wheels via a rack, and a controller configured or programmed to include a position controller. The position controller is configured or programmed to calculate a target rack position for the road wheel actuator based on an actual rack position and a rack position request. The method includes, in response to a requested rack speed being above a predefined maximum value, limiting the requested rack speed to a maximum rack speed value used by the position controller to calculate the target rack position for the road wheel actuator.

The modification of the target rack position enhances maneuverability, reduces post-steering and improves noise, vibration, and harshness (NVH) of the steer-by-wire steering system.

Preferably, the maximum rack speed value is calculated based on vehicle signals and signals of the steering system, for example, based on the vehicle speed and a position misalignment value. In case of normal steering input, the maximum rack speed value is usually higher than the actual rack speed and the rack speed is not limited.

It is advantageous, if the following steps are performed (in the order mentioned): calculating a position tracking error as a deviation between the actual rack position and the target rack position by the position controller, detecting a road wheel actuator power limit situation, and setting the position tracking error to a predefined value and calculating based on the predefined value a target rack position for the road wheel actuator.

These steps will result in maintaining the controllability of the vehicle.

Preferably, to detect the power limit situation in the detecting step, the position tracking behavior of the system is monitored so that if the road wheel actuator cannot follow the target rack position with a position tracking error below a predefined value, a power limit situation is detected.

In the setting step, the position tracking error is preferably reset (the forced control is terminated) as soon as the rack speed requested by a driver falls below the actual rack speed. This makes it possible to restore the tracking ability of the position controller.

Preferably, in the setting step, a steering effort (force) that the driver must apply to the steering for a steering maneuver is increased to signal the situation to the driver.

It is advantageous to, as soon as the rack speed requested by the driver falls below the actual rack speed, gradually reduce a position offset between the rack position request and a target rack position by synchronizing the target rack position to the rack position request of the driver. Further, it is preferred that the steering effort is gradually reduced to a normal level.

The synchronization can be based on (not necessarily limited to) a steering wheel angle, a steering wheel angle speed, a steering wheel torque, an actual misalignment, a vehicle speed, a yaw rate, a lateral acceleration, or a longitudinal acceleration.

For a good steering feel, it is advantageous that the position controller reacts to driver inputs during synchronization.

Further, a steer-by-wire steering system for a road vehicle is provided. The steer-by-wire steering system includes a steering, a road wheel actuator to actuate road wheels via a rack, and a controller configured or programmed to calculate a target rack position for the road wheel actuator based on an actual rack position and a rack position request, which is based on a position of the steering, wherein the controller is configured or programmed to, in response to a requested rack speed being above a predefined maximum value, limit the requested rack speed to a maximum rack speed value used by the position controller to calculate the target rack position for the road wheel actuator.

Preferably, the controller is configured or programmed to include a position controller including a switch configured or programmed to operate in a normal state in which a rack speed limit is used to calculate a rack offset value, which in turn is used to calculate a target rack position, and a power limit state in which a position tracking error is set to a predefined value and based thereon a rack offset value is calculated to calculate a target rack position.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic illustration of a steer-by-wire steering system of a motor vehicle.

FIG. 2 shows a diagram of a rack position over time with rack speed limitation and power limit operation of the road wheel actuator.

FIG. 3 shows a block diagram of a method to control a steer-by-wire system of a motor vehicle.

### DETAILED DESCRIPTION OF THE EXAMPLE EMBODIMENTS

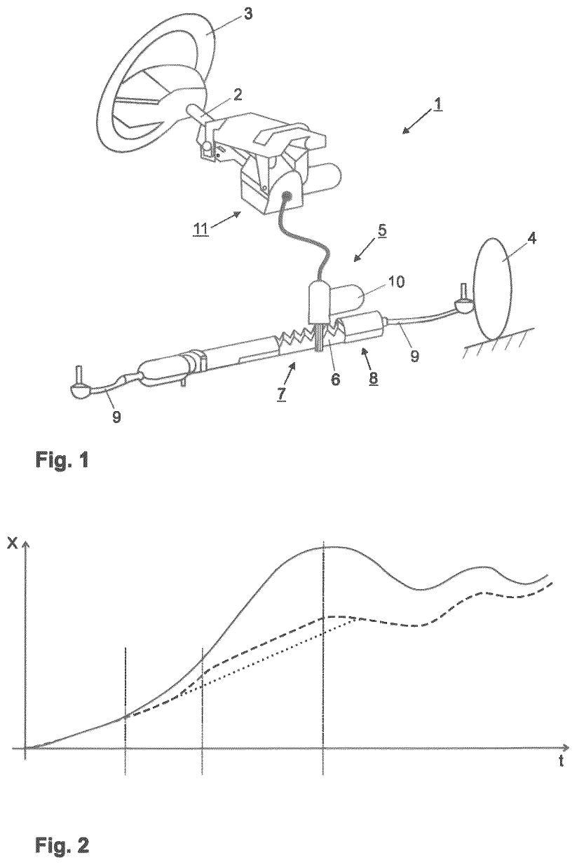

FIG. 1 is a schematic drawing of a steer-by-wire system 1 with a steering shaft 2 connected to a steering 3. There is no mechanical connection between the steering 3 and road wheels 4. A road wheel actuator 5 operates a gear rack 6 via a rack-and-pinion gear 7, which is part of a front wheel axle 8. The front wheel axle 8 includes two tie rods 9 for the road wheels 4, of which only one road wheel 4 is shown.

When a driver operates the steering 3, the steering shaft 2 is rotated, which is detected by a shaft sensor, which is not shown in the drawings. When the vehicle is switched on, a controller 10 is configured or programmed to calculate an operation signal for the road wheel actuator 5 from the signal detected by the shaft sensor. By operating the gear rack 6 with the operation signal, the front wheel axle 8 is moved sideways and the road wheels 4 are turned. At the same time, forces introduced in the wheel axle 8 from the road wheels 4 are recognized by another sensor not shown in the drawings, and a feedback signal is calculated, which is applied to the steering shaft 2 by a feedback actuator 11, so that the operator can recognize the feedback in the steering 3.

The controller 10 is configured or programmed to include a position controller that is configured or programmed to calculate a motor torque based on the actual or an estimated position of the rack 6 and a requested rack position. The road wheel actuator 5 thus follows a target rack position. The requested rack position is dependent on the steering wheel angle.

FIG. 2 shows the rack position x as a function of time t. The solid line represents the requested rack position. The dashed line represents the target rack position and the dotted line represents the actual rack position. Under normal conditions, the road wheel actuator can follow the requested rack position and the requested rack position and the actual rack position are synchronized. This is shown in the first section of the plot. In response to the requested rack speed being above a predefined maximum value, the requested rack speed is limited to a maximum rack speed value. This state is shown in the second section of the plot.

The requested rack speed is limited arbitrarily to reduce operation noise and unexpected odd vehicle motion. The maximum rack speed value is calculated based on vehicle level input signals (such as, but not limited to: vehicle speed, yaw rate, lateral acceleration, longitudinal acceleration, etc.) as-well-as signals of the steering system (such as, but not limited to: steering wheel angle, steering wheel angular speed, steering wheel angular acceleration, steering wheel torque, etc.). In a specific example, the maximum rack speed is determined based on the vehicle speed and the position misalignment.

Normally, the road wheel actuator should be able to track the rack speed limited target rack position in a satisfactory manner. However, if the position tracking error increases above a predefined threshold value (which may depend on the vehicle and/or steering system signals), this is an indication that the road wheel actuator is not able to follow the rack speed limited target rack position. Therefore, a modification of the target rack position is initiated at this time.

In the second section of the diagram, the target rack position is identical to the actual rack position at the beginning. Over time, the deviation between the actual rack position and the target rack position (position tracking error) increases up to the threshold value. This can happen, for example, due to a high steering wheel angle speed input (e.g., a rapid lane change). Such a driver input must mean that the mechanical performance of the road wheel actuator must not be intentionally limited (since such highly dynamic maneuvers occur in emergency situations). In this situation, the position tracking error is forced to a predefined value. This state is shown in the third section of the plot. The forced position tracking error causes the actuator to operate at the power limit, which means that the actuator follows the target position as fast as possible.

At the same time, the steering effort that the driver must apply to the steering wheel for a steering maneuver (the counter steering torque of the feedback actuator) is also increased to signal the “catch-up effect” to the driver. The logic exits the forced position tracking error state as soon as the rack speed requested by the driver falls below the actual rack speed. This is shown in the fourth section of the graph. At this point, the system's ability to track the rack position is restored. At the same time, the increased steering effort is gradually reduced to a normal level. The actual rack position is less than the target rack position. The target rack position and the requested rack position are not synchronized.

The resulting position misalignment (position offset) is handled by a logic, which gradually synchronizes the target rack position to the rack position request of the driver.

The term “logic” or as used herein may include software and/or firmware executable by one or more programmable processors, application-specific integrated circuits (ASICS), field-programmable gate arrays (FPGAs), digital signal processors (DSPs), hardwired logic, or combinations thereof.

The synchronization (reduction of the position offset) happens using, but not limited to the following signals: steering wheel angle, steering wheel angle speed, steering wheel torque, actual misalignment, vehicle speed, yaw rate, lateral acceleration, or longitudinal acceleration. This is done so that the position controller reacts to driver inputs during synchronization (i.e., if the driver steers to the left, the rack turns the wheels to the left as well). If the steering wheel is not turned by the driver, synchronization still occurs over time.

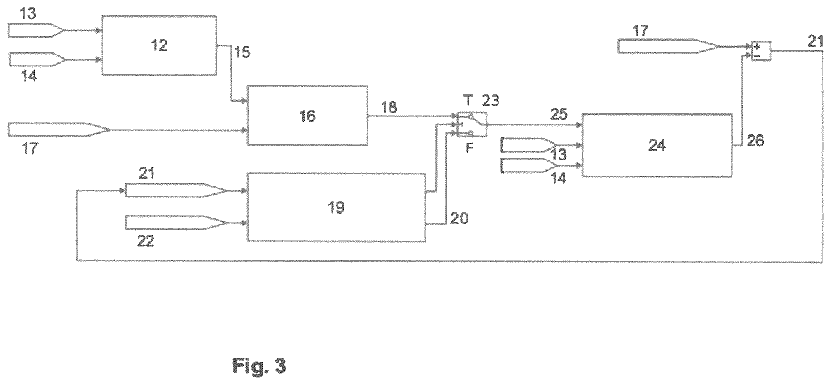

FIG. 3 shows a block diagram of the method described above. A rack speed limiter 12 calculates a rack speed limit 15 based on steering system signals 13 and vehicle signals 14. The limit value is passed on as an input value to a limitation logic 16. In addition, the driver's rack position request (requested rack position) 17 is sent to the limitation logic 16. The limitation logic 16 calculates a rack offset value 18.

Further, a rack position tracking evaluator 19 is configured or programmed to calculate a forced control offset 20 based on the target rack position 21 and the actual rack position 22. A switch 23 is used upstream of a synchronization logic 24. The switch 23 has a normal mode (true). In this normal mode, the rack offset value 18 is passed on from the limitation logic 16 as an offset value 25 to the synchronization logic 24 and the offset value 25, steering system signals 13 and vehicle signals 14 are used to calculate a rack offset value 26 which is used to calculate in addition to the requested rack position 17 a target rack position 21. If the rack position tracking evaluator 19 detects a power limit situation, the switch 23 is switched to power limit mode (false) and the forced control offset 20 is passed on to the synchronization logic 24 as offset value 25 and the synchronization logic 24 calculates based on this offset value 25 a rack offset value 26.

As soon as the rack position tracking evaluator 19 detects an end of the power limit situation, the switch 23 is switched to normal mode.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method to control a steer-by-wire steering system for a road vehicle, the steer-by-wire steering system including a steering, a road wheel actuator to actuate road wheels via a rack, and a controller configured or programmed to include a position controller configured or programmed to calculate, based on an actual rack position and a rack position request, a target rack position for the road wheel actuator, the method comprising:
in response to a requested rack speed being above a predefined maximum value, limiting the requested rack speed to a maximum rack speed value used by the position controller to calculate the target rack position for the road wheel actuator.

2. The method according to claim 1, wherein the maximum rack speed value is calculated based on vehicle signals and signals of the steering system.

3. The method according to claim 1, further comprising:
calculating a position tracking error as a deviation between the actual rack position and the target rack position by the position controller;
detecting a road wheel actuator power limit situation; and
setting the position tracking error to a predefined value and calculating based on the predefined value the target rack position for the road wheel actuator.

4. The method according to claim 3, wherein in the detecting, a position tracking behavior of the system is monitored so that if the road wheel actuator cannot follow the target rack position with the position tracking error below a predefined value, a power limit situation is detected.

5. The method according to claim 3, wherein in the setting, the position tracking error is reset as soon as the rack speed requested by a driver falls below the actual rack speed.

6. The method according to claim 3, wherein the setting includes increasing a steering effort that a driver must apply to the steering for a steering maneuver.

7. The method according to claim 5, wherein as soon as the rack speed requested by the driver falls below the actual rack speed, a position offset between the rack position request and a target rack position is gradually reduced by synchronizing the target rack position to the rack position request of the driver.

8. The method according to claim 7, wherein the synchronizing is based on signals relating to a steering wheel angle, a steering wheel angle speed, a steering wheel torque, an actual misalignment, a vehicle speed, a yaw rate, a lateral acceleration, or a longitudinal acceleration.

9. The method according to claim 7, wherein during the synchronizing, the position controller reacts to driver inputs.

10. A steer-by-wire steering system for a road vehicle, the steer-by-wire steering system comprising:
a steering;
a road wheel actuator to actuate road wheels via a rack; and
a controller configured or programmed to calculate a target rack position for the road wheel actuator based on an actual rack position and a rack position request, which is based on the position of the steering; wherein
the controller is configured or programmed to, in response to a requested rack speed being above a predefined maximum value, limit the requested rack speed to a maximum rack speed value used by the position controller to calculate the target rack position for the road wheel actuator.

11. A steer-by-wire steering system according to claim 10, wherein the controller is configured or programmed to include a position controller including a switch; wherein
the switch is configured or programmed to operate in:
a normal state in which a rack speed limit is used to calculate a rack offset value which in turn is used to calculate a target rack position; and
a power limit state in which a position tracking error is set to a predefined value and based thereon a rack offset value is calculated to calculate a target rack position.
